(19) United States
(12) Patent Application Publication
(10) Pub. No.: US 2017/0317958 A1
(43) Pub. Date: Nov. 2, 2017

(54) DEVICE, SYSTEM AND METHOD OF CREATING AN INVITATION FOR EVENTS AND SOCIAL GATHERINGS THAT DISPLAYS EVENT DETAILS AND ALSO PROVIDES THE RECIPIENT OF THE INVITATION THE ABILITY TO APPLY A RETURN MESSAGE

(71) Applicant: Say Partie, Inc., Santa Clara, CA (US)

(72) Inventors: Matthew Joy, Santa Clara, CA (US); Rolilyn Joy, Santa Clara, CA (US)

(21) Appl. No.: 15/482,140

(22) Filed: Apr. 7, 2017

Related U.S. Application Data
(60) Provisional application No. 62/328,214, filed on Apr. 27, 2016.

(51) Int. Cl. H04L 12/58; G06F 17/24

(52) U.S. Cl. CPC H04L 51/18; G06F 17/24

(57) ABSTRACT

A multipurpose event invitation comprises an event information space for entering event details and an applied message space. The event invitation is configured to be delivered to the sender after being read and updated by a recipient. In some embodiments event details are entered using an event information input and a personalized message is entered using a message space input. In some embodiments, the event invitation is physically delivered to a recipient. Alternatively or in addition, the event invitation is able to be electronically delivered.

### RELATED APPLICATIONS

This Patent Application claims priority under 35 U.S.C. 119(e) of the co-pending U.S. provisional patent application, Application No. 62/328,214, filed on Apr. 27, 2016, and entitled “AN INVITATION FOR EVENTS AND SOCIAL GATHERINGS THAT DISPLAYS EVENT DETAILS AND ALSO PROVIDES THE RECIPIENT OF THE INVITATION THE ABILITY TO APPLY A RETURN MESSAGE,” which is also hereby incorporated by reference in its entirety.

### FIELD OF THE INVENTION

The present invention is generally directed to invitations. More specifically, the present invention is directed to a device, system and method of creating an invitation that displays event details and also provides the recipient of the invitation the ability to apply a return message.

### BACKGROUND OF THE INVENTION

A conventional event invitation typically serves only one purpose, to inform a recipient of event information such as the date, location and a description of the occasion. Typically after the invitation is sent to the recipient, it is then up to the recipient to reply or not reply to the sender. However, this creates uncertainty as to whether a recipient is going to attend the event. Additionally, the host and/or sender of the invitation does not receive feedback from the one or more recipients.

### SUMMARY OF THE INVENTION

A multipurpose event invitation comprises an event information space for entering event details and an applied message space. The event invitation is configured to be delivered to the sender after being read and updated by a recipient. In some embodiments event details are entered using an event information input and a personalized message is entered using a message space input. In some embodiments, the event invitation is physically delivered to a recipient. Alternatively or in addition, the event invitation is able to be electronically delivered.

In one aspect, a multipurpose event invitation comprises an event information space for entering event details and an applied message space, wherein the event invitation is configured to be delivered to the sender after being read and updated by a recipient. In some embodiments, the event information space is on a first side of a invitation body and the prepared message space is on a second side of the invitation body. Alternatively, in some embodiments, the event information space is on a first side of a invitation body and the prepared message space is on an inside of the invitation body. The applied message space enables the recipient to apply a personalized message to the invitation. The invitation is configured to be delivered to the sender after the recipient applies the personalized message to the invitation. In some embodiments, the applied message space is customized by the sender for the recipient. In some embodiments, the multipurpose event invitation is electronically delivered.

In another aspect, a system for creating and sending an event invitation comprises an event information input for entering event details, a message space input for entering a personalized message, a database for receiving the event details and the personalized message, wherein the database stores the event details and the personalized message in an invitation, and an execution engine in communication with the database and that is configured to send the invitation to one or more recipients. In some embodiments, the invitation is configured to be uploaded to the database after the recipient applies the personalized message to the invitation. In some embodiments, a plurality of invitations are uploaded to the database by a plurality of recipients. In some embodiments, the invitation is viewable by the sender. In further embodiments, the invitation is configured to be downloaded from the database by the sender. In some embodiments, the multipurpose event invitation is delivered in an email. In further embodiments, the multipurpose event invitation is delivered in a text message.

In a further aspect, a method of creating and sending an event invitation comprises entering one or more event details, entering a personalized message in a message space, wherein the message space is configured to be customized by a invitation recipient and delivering the event invitation. In some embodiments, the invitation recipient applies a personalized message to the invitation. In some embodiments, the invitation is delivered to the sender. In some embodiments, the invitation is physically delivered. In further embodiments, the message is electronically delivered.

### BRIEF DESCRIPTION OF THE DRAWINGS

Several example embodiments are described with reference to the drawings, wherein like components are provided with like reference numerals. The example embodiments are intended to illustrate, but not to limit, the invention. The drawings include the following figures:

FIGS. 1A and 1B illustrate a multipurpose event invitation in accordance with some embodiments.

FIGS. 2A-2C illustrate a multipurpose event invitation in accordance with some embodiments.

FIGS. 3A and 3B illustrate a multipurpose event invitation in accordance with some embodiments.

FIG. 4 illustrates a schematic view of a system for creating and sending an event invitation in accordance with some embodiments.

FIG. 5 illustrates a method of creating and sending an event invitation in accordance with some embodiments.

### DETAILED DESCRIPTION OF THE EMBODIMENTS

Embodiments of the invention are directed to a multipurpose event invitation comprises an event information space for entering event details and an applied message space. The event invitation is configured to be delivered to the sender after being read and updated by a recipient. In some embodiments event details are entered using an event information input and a personalized message is entered using a message space input. In some embodiments, the event invitation is physically delivered to a recipient. Alternatively or in addition, the event invitation is able to be electronically delivered.

Reference will now be made in detail to implementations of a device, system and method of creating an invitation for events and social gatherings that displays event details and also provides the recipient of the invitation the ability to apply a return message. The same reference indicators will be used throughout the drawings and the following detailed description to refer to the same or like parts. In the interest of clarity, not all of the routine features of the implementations described herein are shown and described. It will be appreciated that in the development of any such actual implementation, numerous implementation-specific decisions can be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

A multipurpose event invitation enables a recipient to direct a message to an event host or celebrant using the same event invitation. Once a multipurpose event invitation has been created with specific event details provided by a host, the invitation is distributed to one or more recipients. The recipient views the invitation and is informed of the event details. The recipient then applies a message to the invitation and the invitation is able to be returned to a host and/or a sender of the invitation.

The multipurpose event invitation is able to be used for a variety of event types. For example, Mary is hosting a birthday party for her 4 year old son, Daniel. She distributes printed multipurpose event invitations to a group of friends and family members (guests). The guests write messages on the multipurpose event invitation that are directed toward the celebrant, Daniel. Before or when the guests arrive at the party they return the multipurpose event invitation. In this manner, the event invitations are able to organized to remember the event (Daniel's birthday) and the persons that were invited.

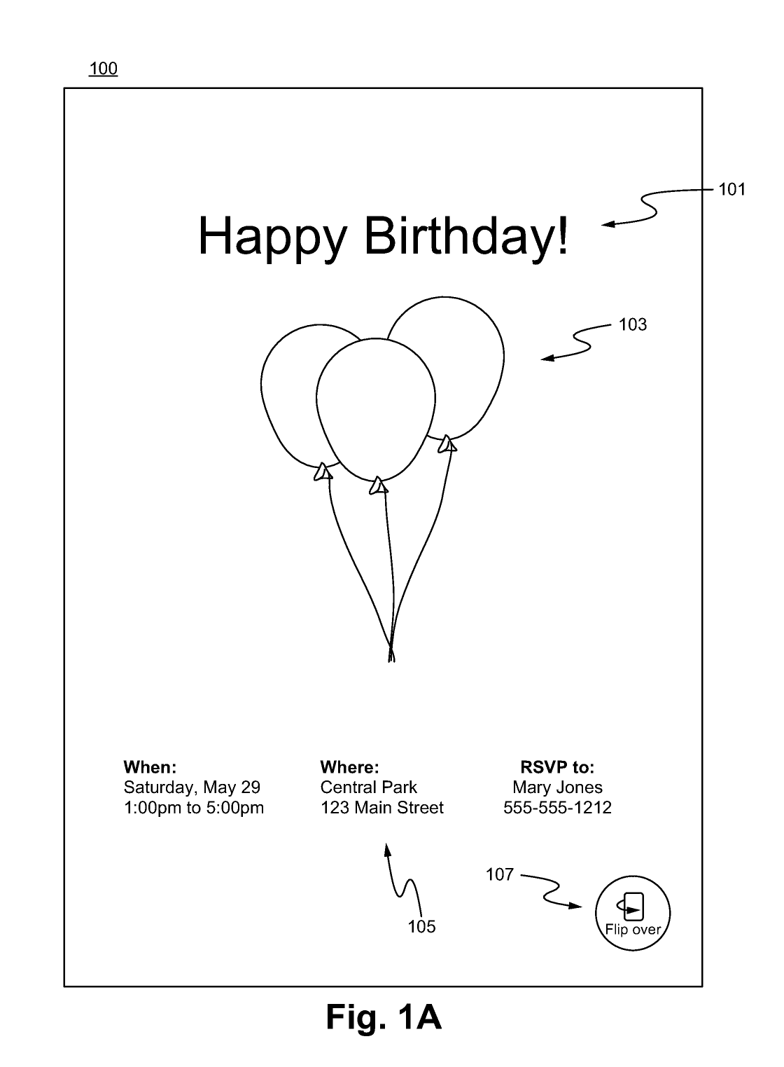

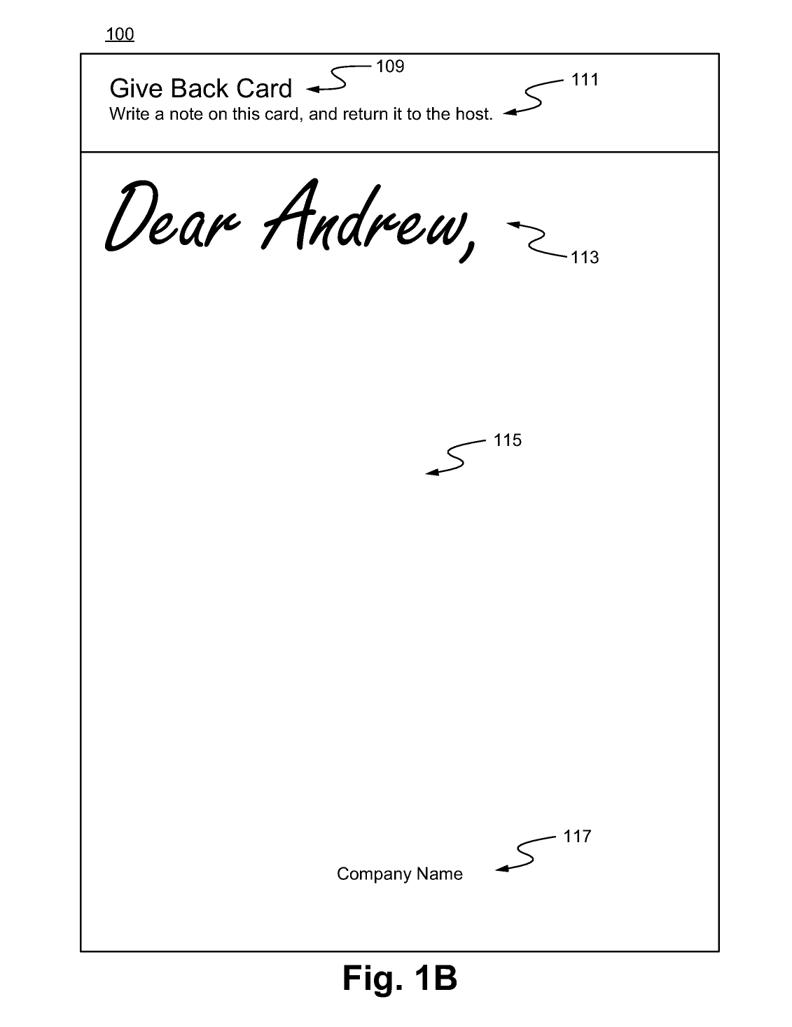

Referring now to FIG. 1A, a first side of a multipurpose event invitation is depicted therein. The multipurpose event invitation 100 comprises a headline message 101, one or more graphical elements of a party theme 103, event details 105, and instructions 107 for using the event invitation 100.

FIG. 1B illustrates a second side of a multipurpose event invitation. As shown within FIG. 1B, in some embodiments, the event invitation 100 comprises a greeting 113 and a blank space for applying a message 115. In some embodiments, the greeting 113 is related to the sender of the invitation 100 and/or the event details 105. The blank space for applying a message 115 enables a recipient of the invitation 100 to apply a personalized message to the invitation and deliver the invitation back to the sender. In some embodiments, the blank space for applying a message 115 is customized by the sender for the recipient. As further shown within FIG. 1B, in some embodiments, the invitation comprises spaces for branding 109 and 117 and instructions 111 on how to use the invitation 100. As would be understood by someone of ordinary skill in the art, the event invitation 100 is able to comprise more or less components as appropriately desired.

As illustrated by FIGS. 1A and 1B, in some embodiments, the event details 105 are on a first side of a invitation body and the blank space for applying a message 115 is on a second side of an invitation body.

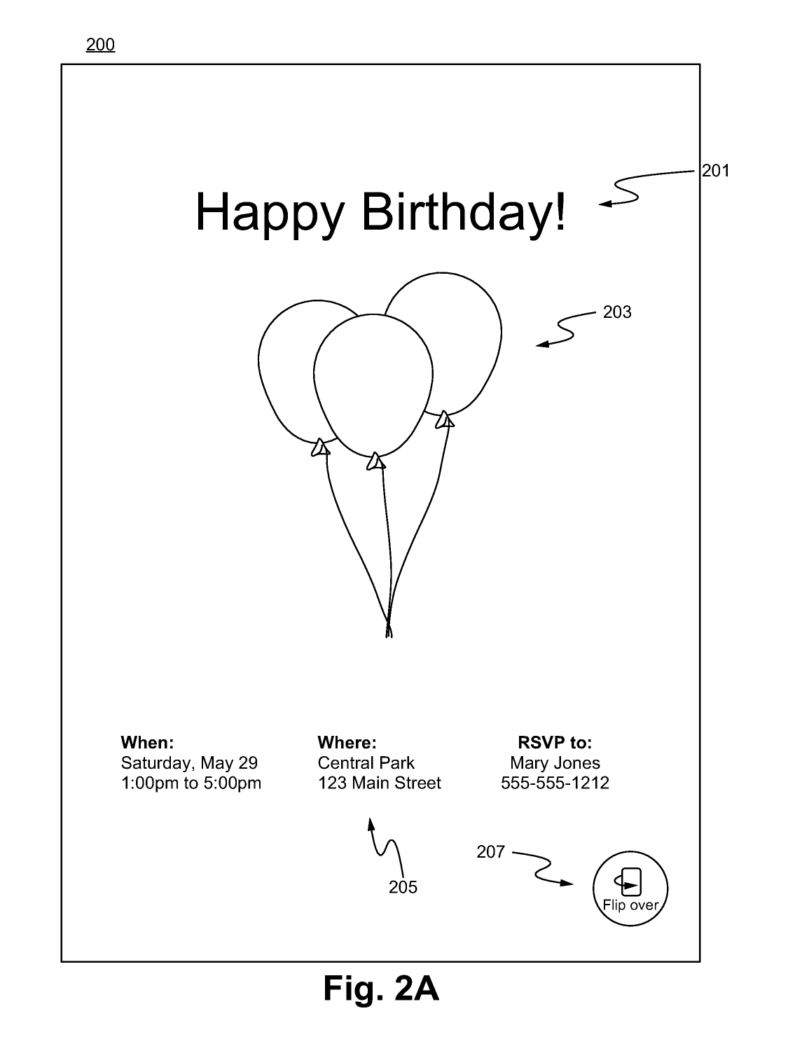

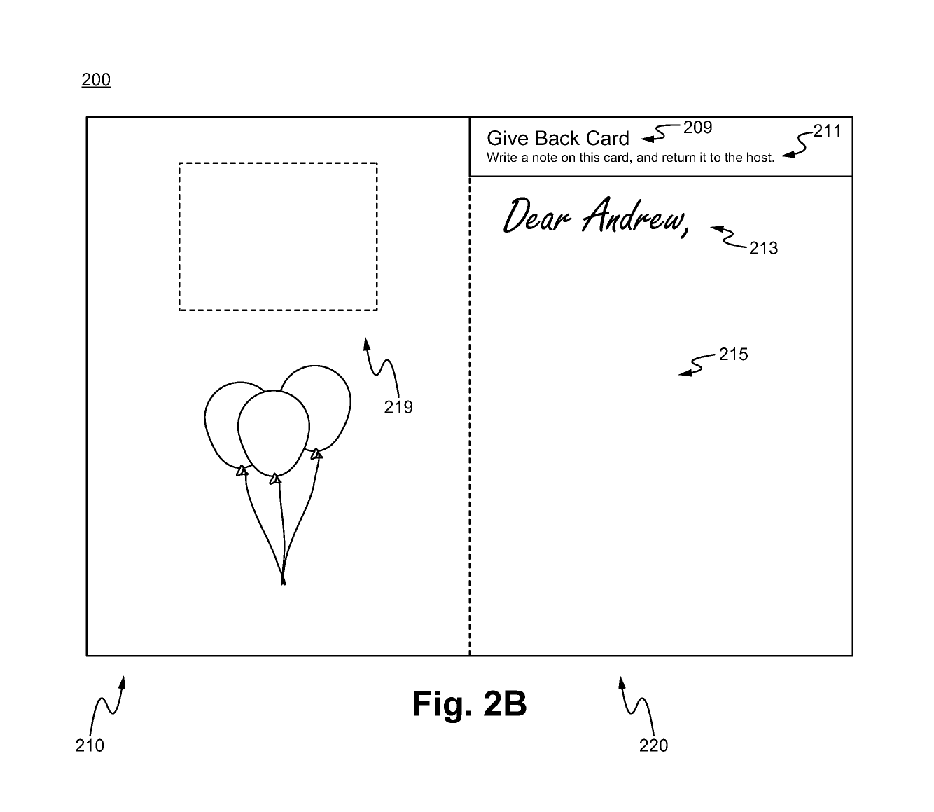

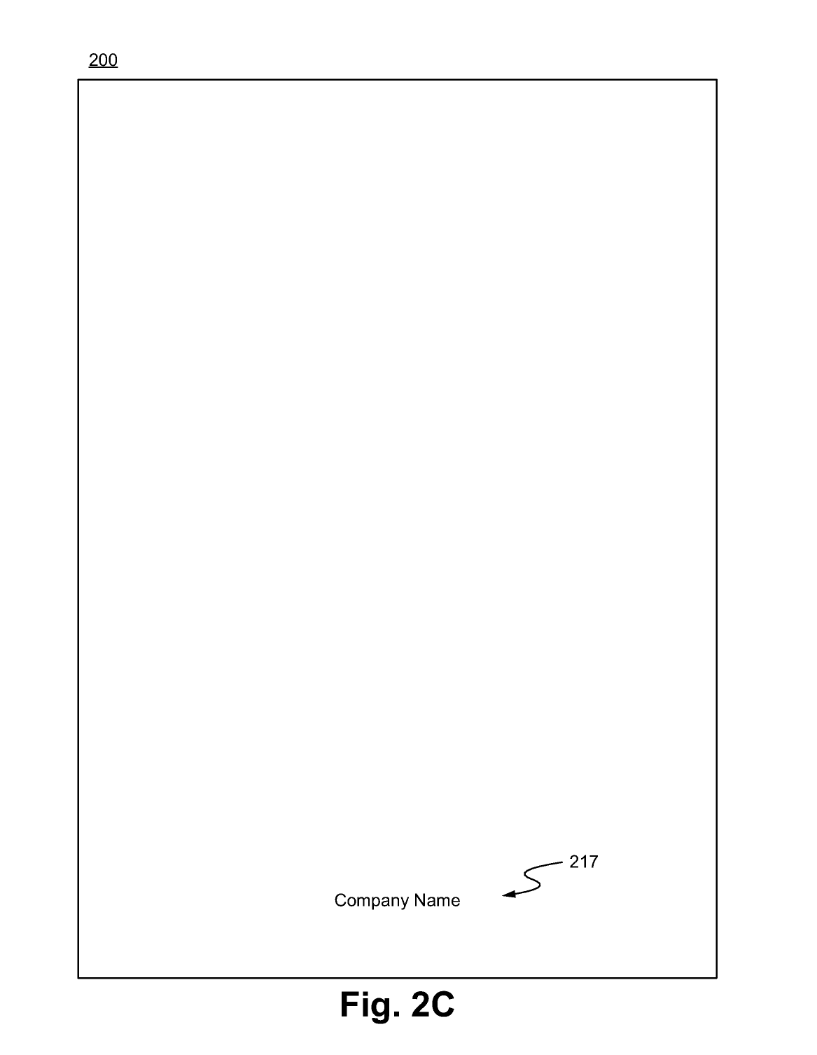

FIGS. 2A-2C illustrate a multipurpose event invitation in accordance with some embodiments. FIG. 2A shows a first side of a multipurpose event invitation. The multipurpose event invitation 200 comprises a headline message 201 one or more graphical elements of a party theme 203, event details 205, and instructions 207 for using the event invitation 200.

FIG. 2B illustrate an inside of the event invitation 200 in accordance with some embodiments. The event invitation 200 comprises a folded event invitation and FIG. 2B illustrates a left inside 210 of the invitation 200 and a right inside 220 of the invitation 200. As shown within FIG. 2B, in some embodiments, the event invitation 200 comprises a greeting 213 and a blank space for applying a message 215. In some embodiments, the greeting 213 is related to the sender of the invitation 200 and/or the event details 205. The blank space for applying a message 215 enables a recipient of the invitation 200 to apply a personalized message to the invitation and deliver the invitation back to the sender. In some embodiments, the blank space for applying a message 215 is customized by the sender for the recipient. As further shown within FIG. 2B, in some embodiments, the invitation comprises spaces for branding 209 and instructions 211 on how to use the invitation 200. In some embodiments, the inside of the invitation 200 also shows one or more graphical elements of a party theme 219. As would be understood by someone of ordinary skill in the art, the event invitation 200 is able to comprise more or less components as appropriately desired. As shown within FIG. 2C, in some embodiments, a back of the invitation 200 comprises a space for branding 217.

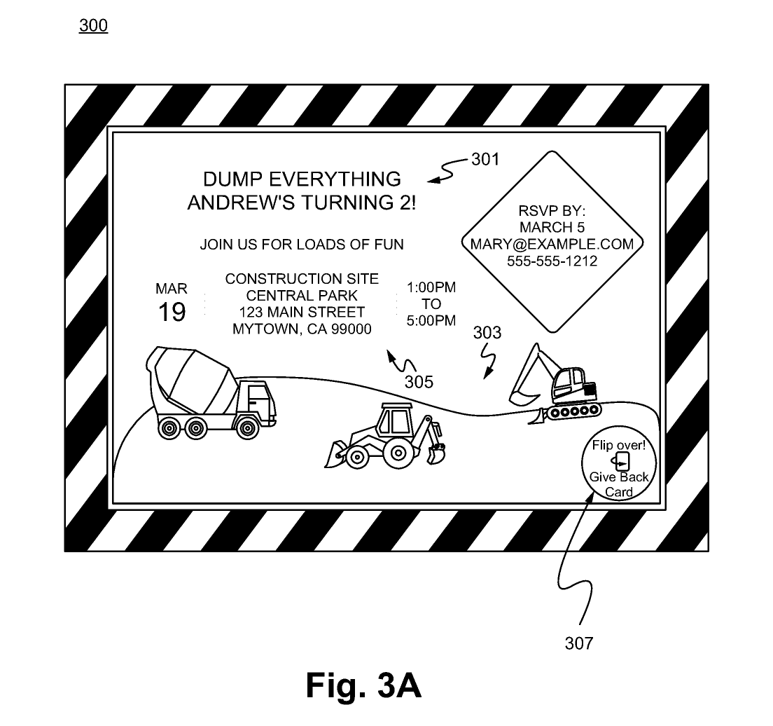

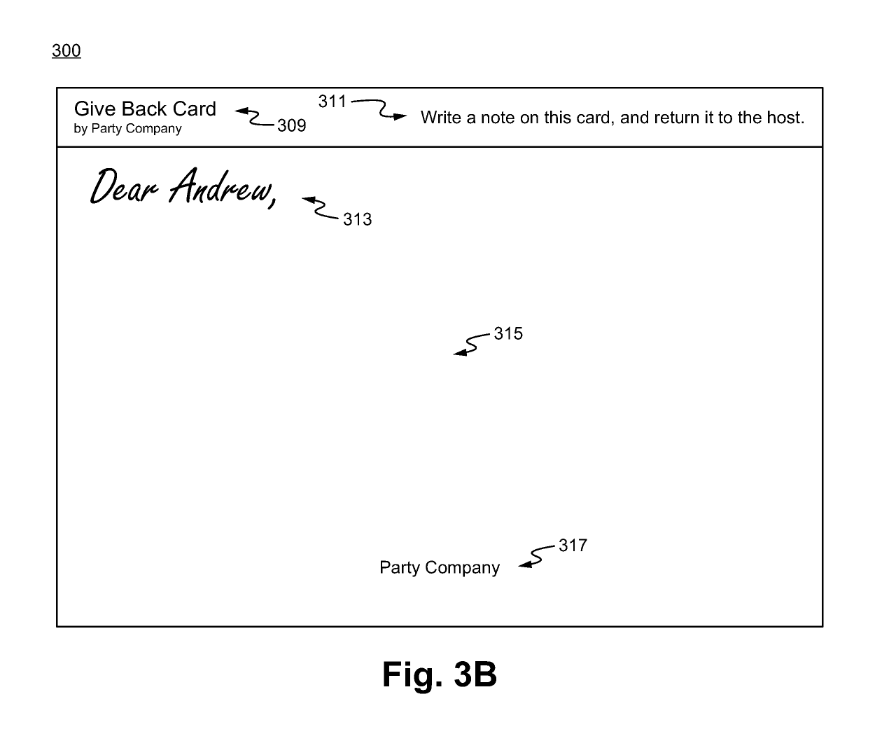

FIGS. 3A and 3B illustrate a front side and a back side of a multipurpose event invitation in accordance with further embodiments. The multipurpose event invitation 300 comprises a headline message 301, one or more graphical elements of a party theme 303, event details 305, and instructions 307 for using the event invitation 300.

FIG. 3B, illustrates a second side of a multipurpose event invitation. As shown within FIG. 3B, in some embodiments, the event invitation 300 comprises a greeting 313 and a blank space for applying a message 315. In some embodiments, the greeting 313 is related to the sender of the invitation 300 and/or the event details 305. The blank space for applying a message 315 enables a recipient of the invitation 300 to apply a personalized message to the invitation and deliver the invitation back to the sender. In some embodiments, the blank space for applying a message 315 is customized by the sender for the recipient. As further shown within FIG. 3B, in some embodiments, the invitation comprises spaces for branding 309 and 317 and instructions 313 on how to use the invitation 300. As would be understood by someone of ordinary skill in the art, the event invitation 300 is able to comprise more or less components as appropriately desired.

As illustrated by FIGS. 3A and 3B, in some embodiments, the event details 305 are on a first side of an invitation body and the blank space for applying a message 315 is on a second side of a invitation body.

The blank spaces for applying a message such as described in relation to FIGS. 1A-3B enable a recipient of an invitation 100, 200 and 300 to apply a personalized message to the invitation 100, 200 and 300 and the invitation 100, 200 and 300 is then able to be delivered back to the sender. In some embodiments, the invitation 100, 200 and 300 is electronically delivered to a recipient and the invitation 100, 200 and 300 is displayed in an email, webpage, text message or other appropriately desired electronic form. Alternatively, or in conjunction, in some embodiments, the invitation 100, 200 and 300 is able to be physically delivered to a recipient.

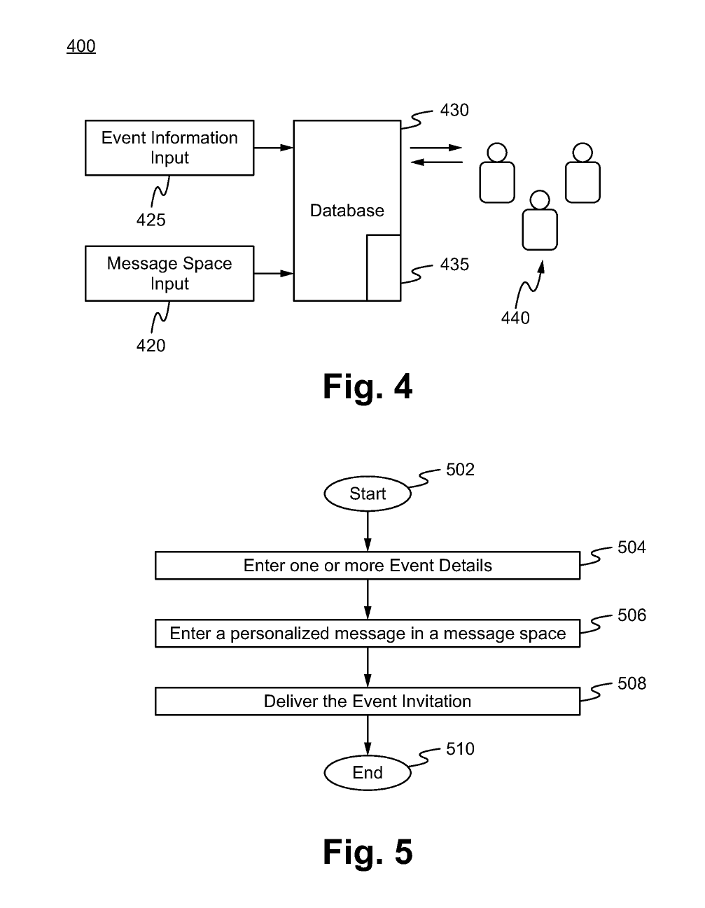

FIG. 4 illustrates a schematic view showing a system for creating and sending an event invitation. The system 400 comprises a message space input 420 for entering a personalized message such as a greeting for the sender and/or the celebrant and an event information input 425 for entering one or more event details such as the date, location and a description of the event. The personalized message and the event information are uploaded to a database 430. The database 430 receives the event details and the personalized message and stores the event details and the personalized message in an invitation. An execution engine 435 coupled to and in communication with the database 430 sends the invitation to one or more recipients 440. The one or more recipients 440 Are able to apply a personalized message to the invitation. In some embodiments, the invitation is then uploaded to the database 430 where it is viewable and/or downloadable by the sender and/or the person that created the event invitation. In some embodiments, the event invitation is able to be downloaded by the recipient and physically delivered to the sender. In some embodiments, the event invitation is delivered in an email. Alternatively, in some embodiments, the event invitation is delivered in a text message. As will be apparent to someone of ordinary skill in the art, the event invitation is able to be delivered by any appropriately desired electronic method.

FIG. 5 illustrates a method of creating and sending an event invitation. The method begins in the step 502. In the step 504, one or more event details are entered. In the step 506, a personalized message is entered in a message space. As described above, the message space is configured to be customized by an invitation recipient. In the step 508, the invitation is delivered. The method ends in the step 510. In some embodiments, the invitation recipient applies a personalized message to the invitation and the invitation is delivered to the sender. In some embodiments, the invitation is physically delivered. Alternatively, in some embodiments, such as described above, the message is electronically delivered.

In a physical form, the multipurpose event invitation is able to be printed on physical media, such as invitation card stock or other appropriately desired material. In the physical form, the invitation is able to be printed on a flat or folded card in portrait and landscape orientation. On a flat card, the event details and graphics are apply to be arranged on a front side with additional graphics on the opposite side. On a folded card, the event details and graphics are able to be arranged on the front side with additional graphics on the inside pages along with space to apply a message.

In a digital or electronic form, the multipurpose event invitation can be delivered by email, text message or any other appropriately desired electronic method. In some embodiments, the presentation of the invitation, application of the message, and the return of the invitation is able to occur on a web page, a software application or other appropriately desired method.

In operation, a multipurpose event invitation is able to include various components such as displays of information including date, location and a description of the event, instructions on how to use the invitation, branding, a greeting, and space for applying a message. The event invitation enables the host or celebrant of an event to obtain a keepsake of an event to remember the event of years to come. Particularly, because recipient messages are included with the invitation, the recipient messages permanently give context to the event for future reference. Additionally, guests of the event are able to save money because they do not have to purchase a separate greeting card and waste is reduced by reusing existing materials for another purpose. As such, the device, system and method of creating an invitation for events and social gatherings that displays event details and also provides the recipient of the invitation the ability to apply a return message as described herein has many advantages.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention.

What is claimed is:

1. A multipurpose event invitation comprising:
a. an event information space for entering event details; and
b. an applied message space, wherein the event invitation is configured to be delivered to the sender after being read and updated by a recipient.

2. The multipurpose event invitation of claim 1, wherein the event information space is on a first side of a invitation body and the prepared message space is on a second side of the invitation body.

3. The multipurpose event invitation of claim 1, wherein the event information space is on a first side of a invitation body and the prepared message space is on an inside of the invitation body.

4. The multipurpose invitation of claim 1, wherein the applied message space enables the recipient to apply a personalized message to the invitation.

5. The multipurpose invitation of claim 4, wherein the invitation is delivered to the sender after the recipient applies the personalized message to the invitation.

6. The multipurpose invitation of claim 1, wherein the applied message space is customized by the sender for the recipient.

7. The multipurpose invitation of claim 1, wherein the multipurpose event invitation is electronically delivered.

8. A system for creating and sending an event invitation comprising:
a. an event information input for entering event details;
b. a message space input for entering a personalized message;
c. a database for receiving the event details and the personalized message, wherein the database stores the event details and the personalized message in an invitation; and
d. an execution engine in communication with the database and that is configured to send the invitation to one or more recipients.

9. The system of claim 8, wherein the invitation is configured to be uploaded to the database after the recipient applies the personalized message to the invitation.

10. The system of claim 9, wherein a plurality of invitations are uploaded to the database by a plurality of recipients.

11. The system of claim 9, wherein the invitation is viewable by the sender.

12. The system of claim 9, wherein the invitation is configured to be downloaded from the database by the sender.

13. The system of claim 8, wherein the multipurpose event invitation is delivered in an email.

14. The system of claim 8, wherein the multipurpose event invitation is delivered in a text message.

15. A method of creating and sending an event invitation comprising:
a. entering one or more event details;
b. entering a personalized message in a message space, wherein the message space is configured to be customized by a invitation recipient; and
c. delivering the event invitation.

16. The method of claim 15, wherein the invitation recipient applies a personalized message to the invitation.

17. The method of claim 16, wherein the invitation is delivered to the sender.

18. The method of claim 15, wherein the invitation is physically delivered.

19. The method of claim 15, wherein the message is electronically delivered.
